(19) United States
(12) Patent Application Publication
(10) Pub. No.: US 2008/0215173 A1
(43) Pub. Date: Sep. 4, 2008

(54) System and Method for Providing Acoustic Analysis Data

(75) Inventors: Wendell T. Hicken, La Verne, CA (US); Frode Holm, Santa Barbara, CA (US); James Edmond Clune, Glendora, CA (US); Marc Elroy Campbell, Monrovia, CA (US)

Correspondence Address: CHRISTIE, PARKER & HALE, LLP, PO BOX 7068, PASADENA, CA, 91109-7068, US

(73) Assignee: MusicIP Corporation

(21) Appl. No.: 12/120,963

(22) Filed: May 15, 2008

Related U.S. Application Data
(62) Division of application No. 10/917,865, filed on Aug. 13, 2004.
Application No. 10/917,865 is a continuation-in-part of application No. 10/668,926, filed on Sep. 23, 2003, now Pat. No. 7,013,301.
Application No. 10/668,926 is a continuation-in-part of application No. 09/885,307, filed on Jun. 20, 2001.
Application No. 09/885,307 is a continuation-in-part of application No. 10/278,636, filed on Oct. 23, 2002.
Application No. 10/278,636 is a continuation-in-part of application No. 09/556,051, filed on Apr. 21, 2000, now abandoned.
Application No. 09/556,051 is a continuation-in-part of application No. 09/340,518, filed on Jun. 28, 1999, now Pat. No. 6,370,513.
(60) Provisional application No. 60/510,876, filed on Oct. 14, 2003.

(51) Int. Cl. G06F 17/00; G06F 7/06; G06F 17/30

(52) U.S. Cl. 700/94

(57) ABSTRACT

A music recommendation system receives a user selection of desired music, retrieves analysis data associated with the selected music, and generates a playlist of songs based on the analysis data. The analysis data is generated based on a processing of one or more audio signals associated with the selected music. The analysis data may downloaded from a central server. If the analysis data is not available from the central server, it is generated locally at a user end, and uploaded to the central server. A plurality of user-selectable shuffling mechanisms are provided to allow the order of the songs to be shuffled according to the selected shuffling mechanism. The end user device may also receive recommendation of new music from different providers based on the analysis data of music for which the recommendation is to be based.

### CROSS-REFERENCE TO RELATED APPLICATION(S)

This application is a divisional of U.S. patent application Ser. No. 10/917,865, filed Aug. 13, 2004 (attorney docket 52075) which claims the benefit of U.S. Provisional Application No. 60/510,876, filed on Oct. 14, 2003 (attorney docket 51076), and is a continuation-in-part of U.S. patent application Ser. No. 10/668,926, filed on Sep. 23, 2003 (attorney docket 50659), and is a continuation-in-part of U.S. patent application Ser. No. 09/885,307, filed on Jun. 20, 2001 (attorney docket 41182), and is a continuation-in-part of U.S. patent application Ser. No. 10/278,636, filed on Oct. 23, 2002 (attorney docket 48763), which in turn is a continuation-in-part of U.S. patent application Ser. No. 09/556,051, filed on Apr. 21, 2000 (attorney docket 37273), which in turn is a continuation-in-part of U.S. Pat. No. 6,370,513, the content of all of which are incorporated herein by reference.

### FIELD OF THE INVENTION

This invention relates generally to automated product recommendation systems, and more specifically, to an automated music recommendation system and method.

### BACKGROUND OF THE INVENTION

There are a number of situations in which a person would like to know whether he or she will like an item before expending time and/or money sampling the item. For instance, when a person must decide on the next book to read, music to listen, movie to watch, painting to purchase, or food to eat, he or she is often faced with a myriad of choices.

Although automated recommendation systems and methods exist in the prior art which may aid an individual in making decisions such as what music to select, meal to cook, book to buy, or movie to watch, such systems are often based on the preferences of other users, and are not based solely on the preferences of the users for whom the recommendations are to be made.

It is therefore desirable to have an automatic system and method of recommending items to a person which are based on the user's preferences, and which are based on an analysis of attributes contained in the items to be recommended.

### SUMMARY OF THE INVENTION

According to one embodiment, the present invention is directed to an audio recommendation system that includes an audio analysis engine processing an audio signal and generating acoustic analysis data in response. A data store stores the generated acoustic analysis data and associates the data to a particular audio piece. A recommendation engine receives a user selection of a first audio piece and retrieves from the data store first acoustic analysis data associated with the first audio piece. The recommendation engine retrieves from the data store second acoustic analysis data associated with a second audio piece and compares the first acoustic analysis data with the second acoustic analysis data. The recommendation engine outputs the second audio piece as a recommended audio piece based on the comparison.

According to one embodiment, the invention is also directed to an audio recommendation system that includes an e-commerce engine that receives a user selection of desired music and retrieves analysis data associated with the selected music from a data store. The analysis data is generated by an analysis engine processing one or more audio signals associated with the selected music. The retrieved analysis data is transmitted to a remote provider server which then generates a recommendation based on the analysis data. The recommendation may be, for example, for an audio piece, album, or artist. The e-commerce engine receives the recommendation from the provider server. The recommendation includes a link to the server which may then be selected to listen, download, or purchase the recommended music.

According to one embodiment, the invention is directed to an end user device in an audio recommendation system that includes a server maintaining in a central data store an acoustic analysis database of acoustic analysis data for a plurality of audio pieces. The end user device includes a first data store storing audio signals for a first audio piece. The end user device also includes a processor executing instructions stored in memory which cause the processor to process the audio signals and generate a first acoustic analysis data in response. The generated first acoustic analysis data is stored in a second data store at the end user device. The end user device further includes a network port used to upload the first acoustic analysis data to the central data store for adding to the acoustic analysis database. The first acoustic analysis data is then used to select a recommended second audio piece.

According to on embodiment, the invention is also directed to a server in an audio recommendation system. The server includes a first data store storing an acoustic analysis database of acoustic data for a plurality of audio pieces. An audio processor receives a query for first acoustic analysis data associated with a first audio piece and searches the acoustic analysis database for the first acoustic analysis data. If the search results in first search results, the audio processor transmits the first acoustic analysis data to the end user device in response. If the search results in second search results, the audio processor receives the first acoustic analysis data from the end user device which processes audio signals for the first audio piece and generates the first acoustic analysis data in response. The first acoustic analysis data is then used to select a recommended second audio piece.

According to one embodiment, the invention is directed to an audio recommendation system that includes a recommendation engine receiving a user selection of desired music and retrieving analysis data associated with the selected music. The analysis data is generated based on a processing of one or more audio signals associated with the selected music. The recommendation engine generates a playlist of songs based on the analysis data. The system also includes a graphics user interface that provides a plurality of user-selectable shuffling mechanisms. The graphics user interface receives a user selection of a particular shuffling mechanism and invokes a shuffling routine to shuffle an order of the playlist based on the user-selected shuffling mechanism.

According to one embodiment, a feature of the invention is a music management system that respects the copyrights of the subject music. Musical pieces owned by a consumer remain stored in the consumer's playback equipment or other end user device and are not copied to any other equipment. When a consumer begins use of the system, each musical piece in the consumer's library is addressed. The consumer's equipment is programmed to perform the following functions: 1) interrogate a central recommendation server to determine if the attributes of the addressed piece are stored at the recommendation server; 2) if the attributes of the addressed piece are stored at the recommendation server, download them to the consumer's equipment for use; and 3) if the attributes of the addressed piece are not stored at the recommendation server, a) generate attributes for the addressed piece; b) store these attributes at the consumer's equipment; and c) send these attributes to the central recommendation server for use by all the consumers in the system. In summary, the music management system performs its functions, including generating play lists, by transmitting the attributes of musical pieces without copying or transmitting the musical pieces themselves. Instead of musical pieces, the system could be used to manage other copyrighted works, such as movies, books, or art.

According to one embodiment, another feature of the invention is a distributed database of attributes for musical pieces, or other copyrighted works, in a music management system. The attributes are stored at various external locations in addition to the internal locations such as a recommendation server and consumers' end user devices. For example, the external locations may be retail outlets where the musical pieces are available for sale. When a consumer commands the recommendation server to search for attributes stored at the external locations such as the retail stores, the recommendation server establishes a connection to one or more external locations and the attributes stored at the external locations are compared with the attributes of a musical piece and the matching titles or other identifying data are transmitted for use in generating, for example, a playlist. In summary, the attributes at the selected external locations are treated as though they are an extension of the internal data base.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a simplified, semi-schematic block diagram of an exemplary automatic profiling, recommendation, and purchasing system according to one embodiment of the invention;

FIG. 2 is a block diagram of a recommendation server according to one embodiment of the invention;

FIG. 3 is a block diagram of a central data store coupled to the recommendation server of FIG. 2 according to one embodiment of the invention;

FIGS. 4A-4B are block diagrams of an end user device according to one embodiment of the invention;

FIG. 5 is a process flow diagram executed by the end user device of FIGS. 4A-4B for populating a music library with audio analysis data and other types of audio information according to one embodiment of the invention;

FIG. 6 is a flow diagram of an audio processing step according to one embodiment of the invention;

FIGS. 7A-7C are illustrations of a mixer GUI generated by a downloaded mixer GUI engine according to one embodiment of the invention;

FIGS. 8A-8B are flow diagrams of a process for generating a playlist according to one embodiment of the invention;

FIG. 9 is a flow diagram for shuffling the order of songs of a playlist according to one embodiment of the invention;

FIG. 10 is a flow diagram of a process for generating a list of similar artists or albums according to one embodiment of the invention; and

FIG. 11 is a flow diagram of a process for receiving recommendations of songs or albums provided by different providers for purchase, download, and/or listening, according to one embodiment of the invention.

### DETAILED DESCRIPTION OF THE INVENTION

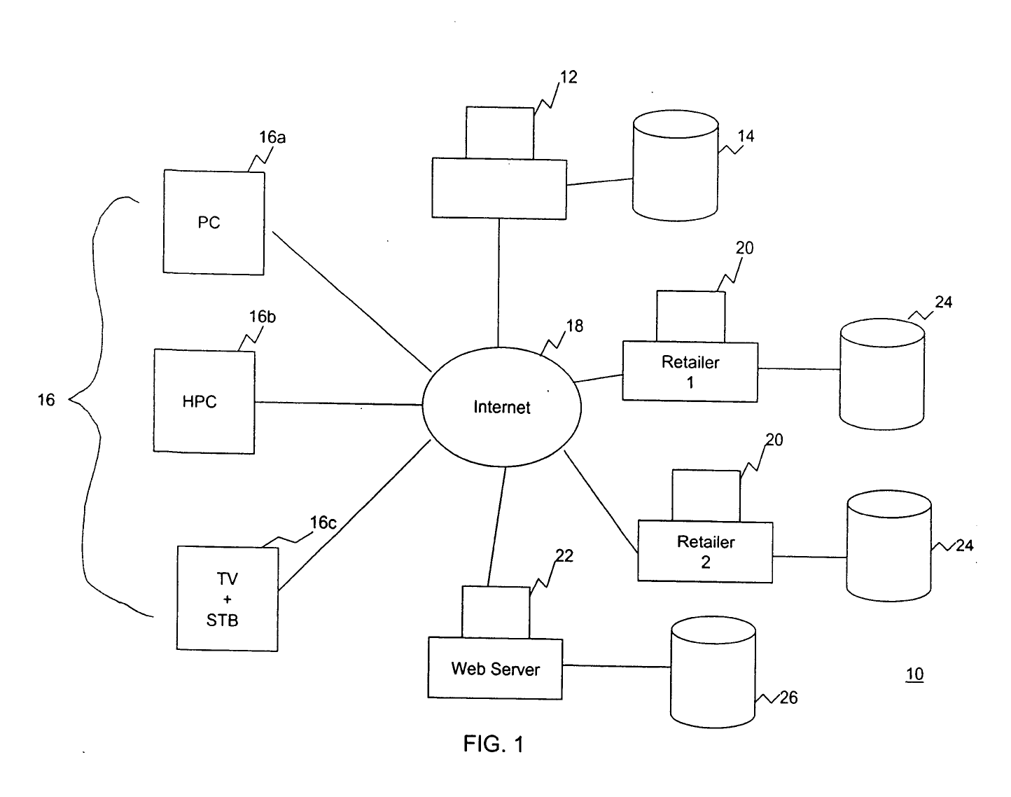

FIG. 1 is a simplified, semi-schematic block diagram of an exemplary automatic profiling, recommendation, and purchasing system 10 according to one embodiment of the invention. The system includes a profiling and recommendation server or platform computer (referred to as the recommendation server) 12 coupled to a central data store 14. The recommendation server 12 is coupled to one or more end user devices 16 over a private or public wide area network such as, for example, the public Internet 18. Also coupled to the public Internet 18 using conventional wired or wireless data communication links are retailer servers 20 and web servers 22. The retailer and web servers 20, 22 are respectively coupled to retailer and web server data stores 24, 26 that store information for use in the system 10.

According to one embodiment of the invention, the end user devices 16 may connect to the public Internet 18 via telephone lines, satellite, cable, radio frequency communication, or any wired or wireless data communications device known in the art. To this end, the end user devices 16 may take the form of a personal computer (PC) 16a, hand-held personal computer (HPC) 16b, television and set-top-box combination 16c, a portable audio player, and the like.

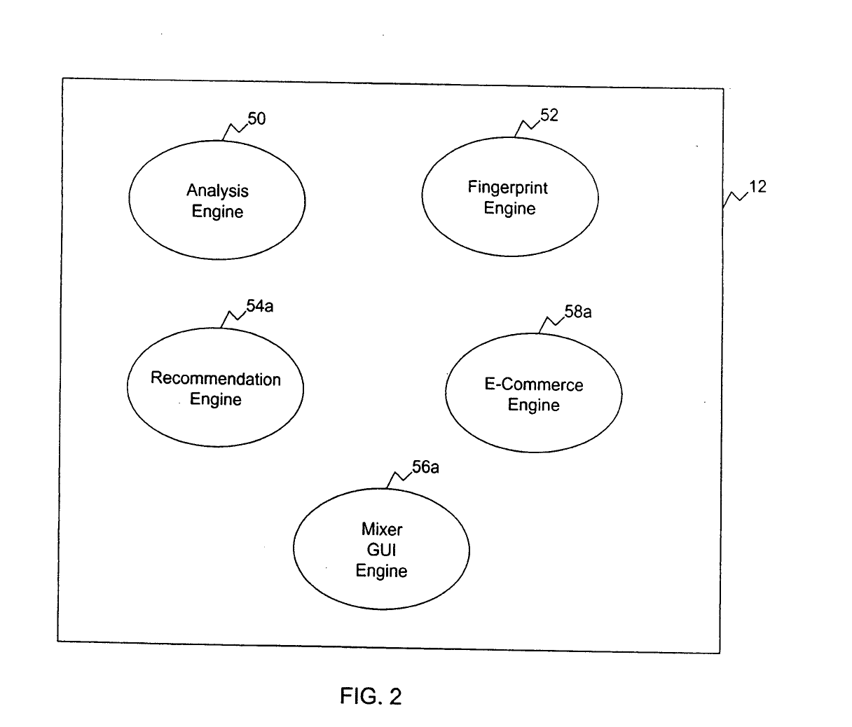

FIG. 2 is a more detailed block diagram of the recommendation server 12 according to one embodiment of the invention. The recommendation server 12 includes an analysis engine 50, fingerprint engine 52, recommendation engine 54, music mixer graphics user interface (GUI) engine 56, and e-commerce engine 58. One or more of the engines included in the recommendation server 12 may be downloaded to an end user device 16 in response to a user request. One or more of these engines may also be downloaded to the retailer server 20 and/or web server 22.

According to one embodiment of the invention, client versions of all of the engines 50-58 provided by the recommendation server 12 are packaged into a single client application package, referred to as a music mixer package, and downloaded to the end user device over the Internet 18. According to one embodiment of the invention, at least the recommendation engine 54 is also downloaded to the retailer server 20 and/or web server 22. The recommendation engine 54 may be downloaded over the Internet 18, or retrieved from a local data store coupled to the retailer server 20 or web server 22. A person of skill in the art should recognize, however, that other engines residing in the recommendation server 12, such as, for example, the analysis engine 50 and fingerprint engine 52, may also be downloaded and/or embedded into the retailer and/or web servers 20, 22.

According to one embodiment of the invention, the analysis engine 50 automatically analyzes the audio signals of an audio piece for determining its acoustic properties, also referred to as attributes. These properties may be, for example, tempo, repeating sections in the audio piece, energy level, presence of particular instruments such as, for example, snares and kick drums, rhythm, bass patterns, harmony, particular music classes, such as, for example, a jazz piano trio, and the like. For example, the value associated with the tempo attribute measures a tempo for the audio piece as detected via a tempo detection algorithm. The value associated with the repeating sections attribute measures a percentage of the audio piece with repeating sections/patterns as detected by a repeating section analysis module. The value associated with a particular musical class attribute indicates how close or far the audio piece is to the musical class. The software modules used for computing the value of the various acoustic attributes are described in more detail in U.S. patent application Ser. Nos. 10/278,636 and 10/668,926. As the value of each acoustic attribute is computed, it is stored into an acoustic attribute vector, also referred to as an audio description or audio analysis data. The acoustic attribute vector maps calculated values to their corresponding acoustic attributes.

The analysis engine 50 may further generate group profile vectors for a particular group of audio pieces, such as, for example, for a particular album, artist, or other collection of songs. According to one embodiment of the invention, a group profile is generated based on the acoustic attribute vector of a plurality of audio pieces in the group. The group profile may be represented as group profile vector that stores coefficient values for the various attribute fields of an acoustic attribute vector. Each coefficient value may be represented as a ratio of points of deviation that is represented by the following formula:

(avg[sub]−avg[all])/var[all]

where avg[all] is the average value of a particular attribute across all the known songs in a current database, avg[sub] is the average value of the particular attribute across a subset of the songs belonging to the group for which the profile is to be generated, and var[all] is a variance of the values computed for the particular attribute across all the known songs.

According to one embodiment of the invention, a coefficient value of a particular attribute is high if the subset of songs is typically different from the average of a larger group of songs with respect to the attribute, or if the variance value is small. Thus, the coefficients help determine the most distinct and unique attributes of a set of songs with respect to a larger group. Additionally, the sign of the coefficient indicates the direction in which the subset of songs is different than the average.

The fingerprint engine 52 is configured to generate a compact representation, hereinafter referred to as a fingerprint or signature, of an audio piece, for use as a unique identifier of the audio piece. According to one embodiment of the invention, the fingerprint engine, or a separate engine, takes various frequency measurements of the audio piece by calculating, for example, a Fast Fourier Transform of the audio signal. The fingerprint engine 52 then builds matrix A based on the frequency measurements, and performs a well known matrix operation known as a Singular Value Decomposition (SVD) operation on matrix A, where A=USV^{T}. According to one embodiment of the invention, the row of matrix V^{T} are selected as the audio fingerprint since it captures the most variance, that is, retain the most information about the audio piece in decreasing order of significance as measure by the diagonal entries of the S matrix.

The fingerprint engine 52 is further configured to receive a generated fingerprint and search for a match for retrieving information associated with the matching fingerprint. The fingerprint engine 52 is described in more detail in U.S. patent application Ser. No. 10/668,926.

The analysis and/or fingerprint engines 50, 52 may further include a preprocessor engine (not shown) for taking certain pre-processing steps prior to analysis of an audio file. Such pre-processing steps may include, for example, normalizing an audio signal, transforming a stereo audio signal to mono, eliminating silent portions of the signal, and the like. The preprocessor engine may also be a stand-alone engine coupled to the analysis and fingerprint engines 50, 52.

The recommendation engine 54 is configured to receive a source acoustic attribute vector and generate a recommendation of one or more audio pieces based on the source acoustic attribute vector. The source acoustic attribute vector may also be referred to as a user preference vector. According to one embodiment of the invention, the recommendation engine 54 retrieves one or more products whose audio description is closest to the source audio description.

The mixer GUI engine 56 provides a graphics user interface (hereinafter referred to as a mixer GUI) for allowing a user to view his or her music files in an organized manner according to different categories, such as, for example, according to genre, artist, or album. The mixer GUI further allows a user to play the music files, search for particular artists, albums, or songs, generate playlist mixes, modify generated playlist mixes, purchase, download, or listen to albums or songs from different providers, and the like.

The e-commerce engine 58 allows a user to receive from different providers, ideas for new music not currently stored in the user's music database. In this regard, responsive to a command provided by the user via the mixer GUI, the e-commerce engine 58 may communicate with retailer servers 20 to transmit a recommendation request for music maintained in their data stores 24. The communication between the e-commerce engine 58 and the retailer servers 20 may be based on a service oriented messaging protocol such as, for example, SOAP (Simple Object Access Protocol).

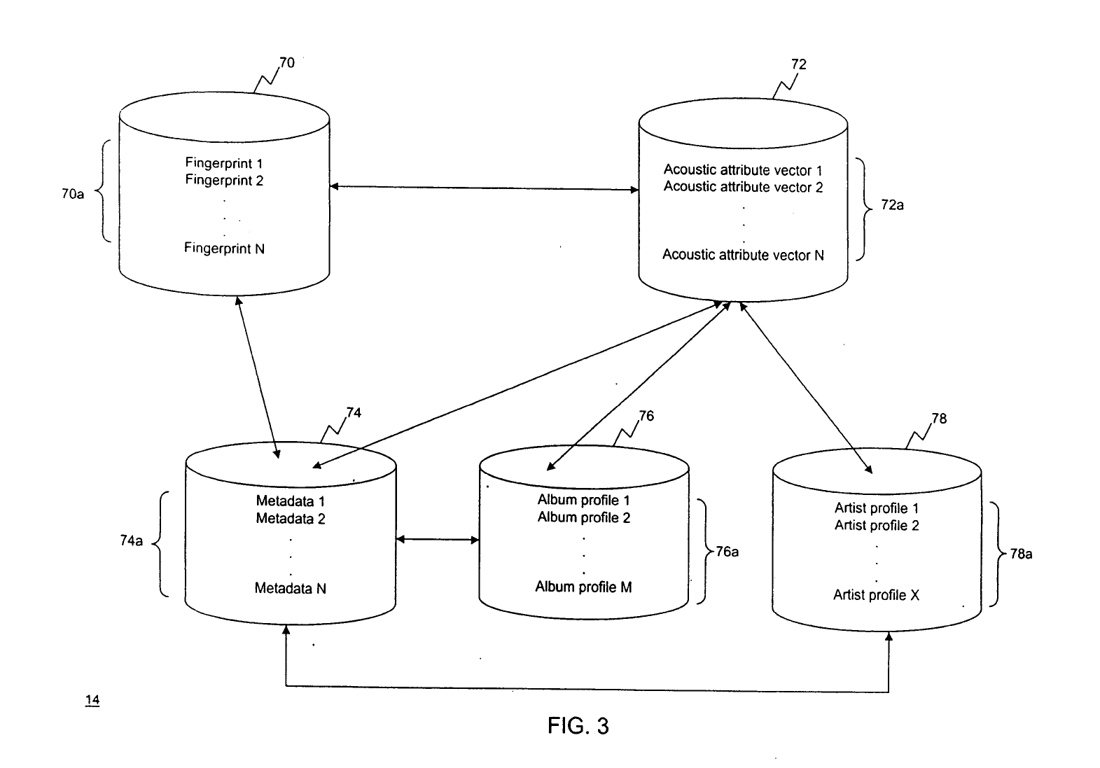

FIG. 3 is a more detailed diagram of the central data store 14 according to one embodiment of the invention. The central data store, which may be implemented as a hard disk drive or drive arrays, stores a fingerprint database 70, audio profile database 72, metadata database 74, album profile database 76, and artist profile database 78. A person of skill in the art should recognize that two or more of these databases may be combined into a single database, or a single database split into two or more separate databases.

According to one embodiment of the invention, the fingerprint database 70 stores an audio fingerprint 70a of an audio piece generated by the fingerprint engine 52. The audio fingerprints 70a are grouped into discrete subsets based on particular musical notes contained in the audio pieces. The particular musical notes are used as an index to a particular subgroup of fingerprints in the fingerprint database.

The fingerprint database 70 is coupled to an audio profile database 72. The audio profile database stores for an audio fingerprint in the fingerprint database 70, an acoustic attribute vector 72a generated by the analysis engine 50. The acoustic attribute vector 72a is generated upon analysis of a corresponding audio piece. According to one embodiment of the invention, an acoustic attribute vector 72a maintains a mapping of values to their corresponding acoustic attributes. These attributes may be, for example, tempo, repeating sections, band saturation, snare/kick drum sounds, rhythm, bass level, chord, a particular musical class (e.g. a jazz piano trio), and the like. The value mapped to a particular acoustic attribute allows the attribute to be quantified in the audio piece. The audio piece may thus be described in terms of these acoustic attributes.

According to one embodiment of the invention, the generating of acoustic attribute vectors is distributed to the end user devices 16, retailer servers 20, and/or web servers 22. Once generated by an instance of an analysis engine 50 downloaded to one of these devices, an acoustic attribute vector for an analyzed audio piece is transmitted to the recommendation server 12 for storing in the audio profile database 72. In this manner, the audio profile database 72 is populated with analysis data of different audio pieces without requiring the recommendation server 12 to copy the actual audio pieces from the end user devices. This allows the copyrights of the audio pieces to be respected without limiting the generation of analysis data.

The audio profile database 72 is coupled to the metadata database 74, album profile database 76, and artist profile database 78. According to one embodiment of the invention, the metadata database 74 stores metadata information 74a for a corresponding audio piece. All or a portion of the metadata information 74a may be retrieved from a header portion of a music file, and may include, for example, a song title, an artist name, an album name, a track number, a genre name, a file type, a song duration, a universal product code (UPC) number, a link to an external provider of the audio piece or album, and/or the like. A song's metadata may be used to find a corresponding acoustic attribute vector, and vice versa.

The album profile database 76 and artist profile database 78 respectively store the profile vector of an album/CD and artist 76a, 78a associated with an audio piece. The album and artist profile vectors 76a, 78a are generated by the analysis engine 50 based on the above-described mechanism for generating group profile vectors. An acoustic attribute vector may be used to locate associated metadata and album or artist profile vectors, and vice versa.

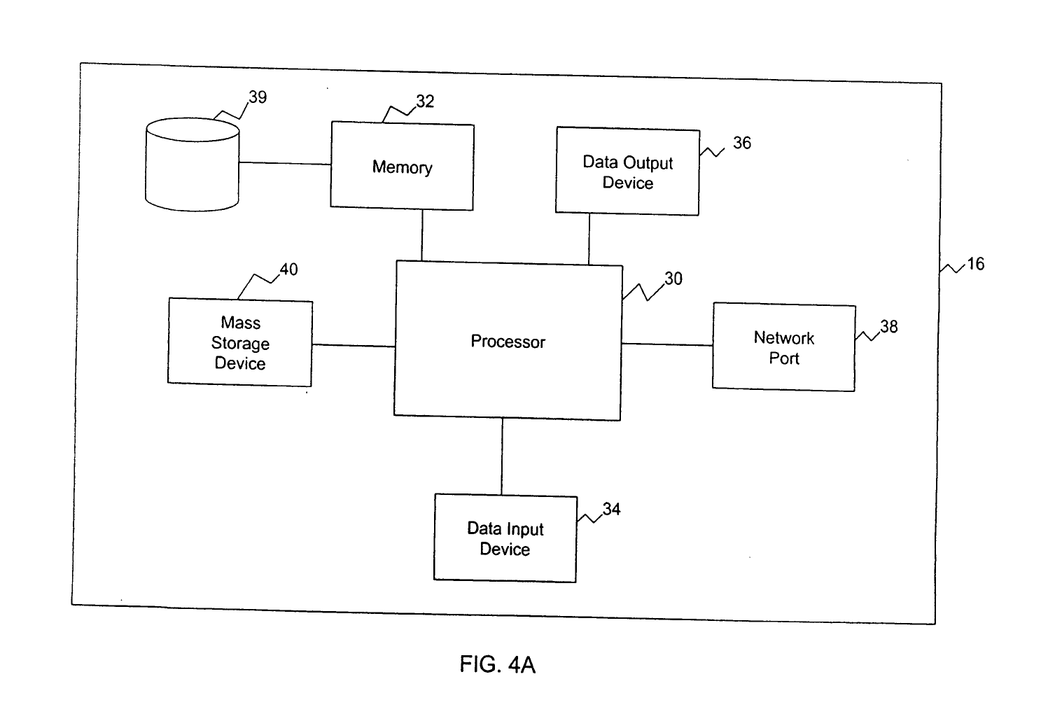

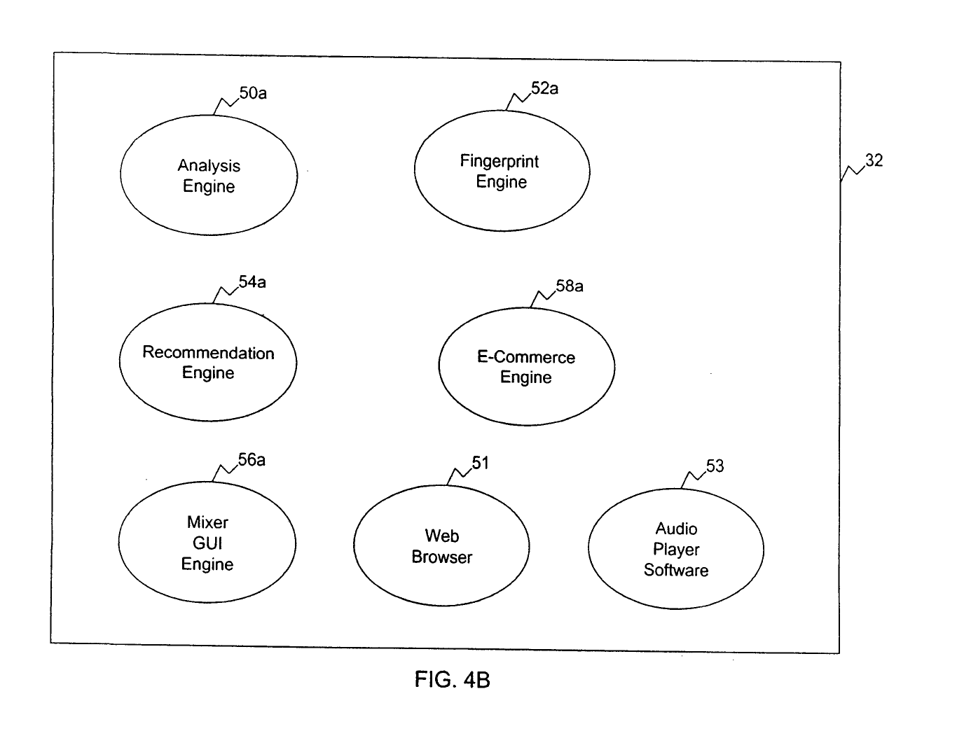

FIGS. 4A-4B are more detailed block diagrams of the end user device 16 according to one embodiment of the invention. The device includes a processor 30, memory 32, data input device 34, data output device 36, network port 38, and mass storage device 40. The data input device 34 may include an audio player such as, for example, a compact disc (CD) player, digital versatile disc (DVD) player, or the like. The data input device 34 may further include a keyboard, keypad, stylus, microphone, remote controller, and the like.

The data output device 36 may include a computer display screen, speakers, and the like. Pressure sensitive (touch screen) technology may also be incorporated into the display screen for allowing a user to provide additional data input by merely touching different portions of the display screen.

The mass storage device 40 may include a static random access memory device, a hard disk, another user portable device, audio player, CD burner, and/or the like.

The network port 38 may be configured to allow the end user device to connect to the Internet 18 and access the recommendation server 12, retailer servers 20, and/or web servers 22.

The memory 32 may include a read only memory, random access memory, flash memory, and the like. The memory 32 stores computer program instructions including the various engines downloaded from the recommendation server 12. The memory 32 also stores in one or more different files, the actual audio pieces owned by the user. The memory 32 further stores in a music library 39, an audio piece's fingerprint, acoustic vector, and metadata information. The music library 39 may further store an album profile as well as an artist profile associated to the audio piece. According to one embodiment of the invention, the audio fingerprint, acoustic attribute vector, album profile vector, and artist profile vector may be generated locally or downloaded from the recommendation server 12.

The processor 30 may take the form of a microprocessor executing computer program instructions stored in the memory 32. According to one embodiment of the invention, the processor receives different types of audio files and outputs them as a wave (.wav) file, MP3 file, or the like. In this regard, the processor 30 may have access to an MP3 decoder for decoding MP3 audio files.

The processor 30 further retrieves and executes computer program instructions associated with the various engines stored in the memory 32 to implement the mixer GUI, analyze songs, generate playlists, purchase albums, and the like. These engines include an analysis engine 50a, fingerprint engine 52a, recommendation engine 54a, e-commerce engine 58a, and mixer GUI engine 56a, which may be similar to the corresponding engines 50-56 in the recommendation server 12. The end user device 16 further hosts a web browser 51 for viewing Hypertext Markup Language pages. The end user device 16 also includes audio player software 53 for playing various types of music files.

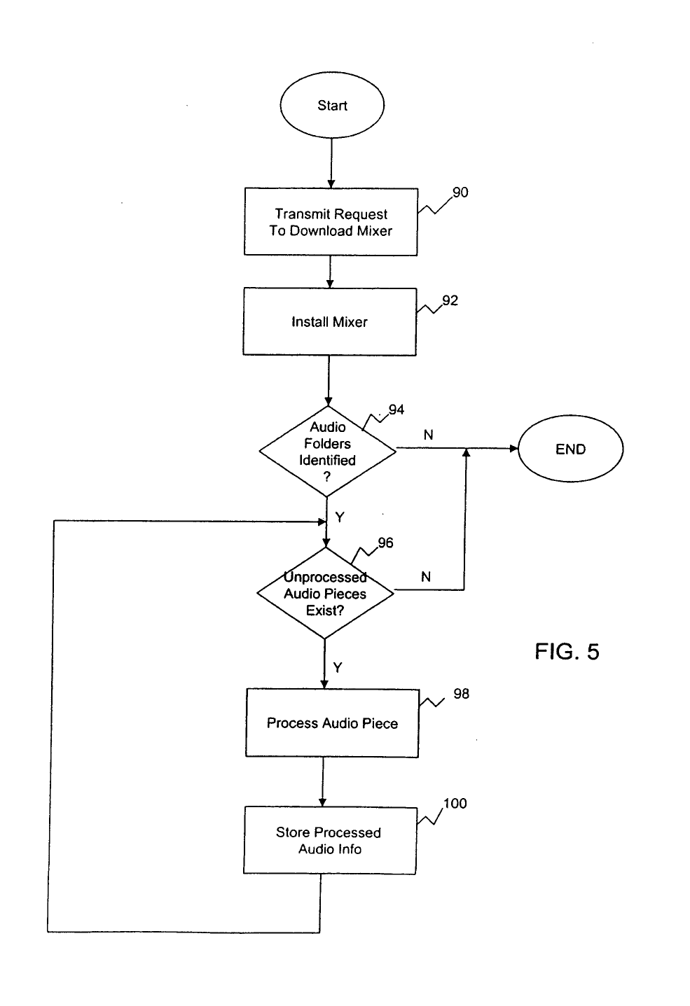

FIG. 5 is a process flow diagram executed by the processor 30 at the end user device 16 for populating the music library 39 with audio analysis data and other types of audio information according to one embodiment of the invention. The process, in step 90, transmits via the network port 36 a user request to download the mixer package from the recommendation server 12. According to one embodiment of the invention, the mixer package includes the client versions of the analysis, fingerprint, recommendation, e-commerce, and mixer GUI engines 50a-58a. The recommendation server 12 receives the request and transmits the mixer package to the end user device 16. According to one embodiment of the invention, the recommendation server 12 may impose certain prerequisites before allowing the download of the mixer package. For example, the recommendation server 12 may request that the user provide his or her registration information, and/or that the user provide payment for the mixer package.

In step 92, the processor 30 receives the mixer package and installs it in the memory 32.

In step 94, a determination is made as to whether audio folders containing audio files stored in the user's memory 32 and mass storage device 40 have been identified. During the installation of the mixer package, the process automatically causes display of a browser on the data output device 36 with various folders stored in the memory 32, and requests the user to select the folders that contain the audio pieces to be processed. The browser may also later be manually invoked for selecting additional folders after installation is complete.

If audio folders containing music to be analyzed have been identified by a user via the data input device 34, a determination is made in step 96 as to whether any of the identified audio folders contain unprocessed audio pieces. If the answer is YES, each unprocessed audio piece is processed in step 98, and any information returned from the processing step stored in the music library 39 in step 100.

According to one embodiment of the invention, the process monitors all audio folders identified in step 94, and upon a detection of a new audio file added to a monitored folder, the process automatically invokes steps 96-100 for processing the audio piece and generating its analysis data. If an audio piece is added to an audio folder that is not automatically monitored, the processing of the audio piece may be manually invoked via the mixer GUI by selecting an add songs option (not shown) from the library menu 204. Once manually invoked, the new audio folder is included in the list of audio folders that are automatically monitored.

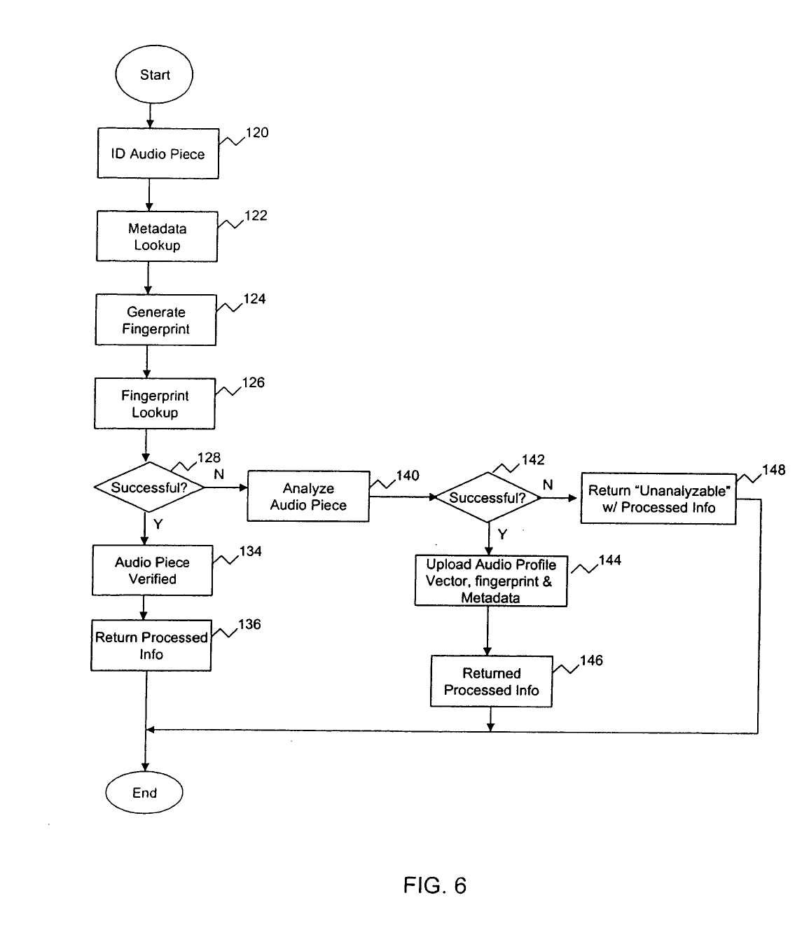

FIG. 6 is a more detailed flow diagram of the audio processing step 98 for a particular audio piece according to one embodiment of the invention. The process, in step 120, identifies the audio piece by, for example, reading a metadata tag attached to the audio piece. The metadata tag may include, for example, a song title, an artist name, an album name, a track number, a genre name, a file type, a song duration, a UPC number, a link to a provider website, and the like. Other information about the audio piece may also be identified, such as, for example, a file location, file size, and the like.

In step 122, the process performs a metadata lookup of the audio piece at the recommendation server 12. In this regard, the process transmits to the recommendation server 12a, a metadata lookup request with all or a portion of the identified metadata, such as, for example, a song title. The recommendation server 12 receives the metadata lookup request, and in response, performs a lookup of the received metadata in the metadata database 74. If the recommendation server 12 finds a match, an acoustic attribute vector 72a associated with the matched metadata 74a is retrieved and transmitted to the end user device 16. Other types of profile vectors such as, for example, an album and/or artist profile vector 76a, 78a associated with the retrieved acoustic attribute vector 72a may also be retrieved and transmitted to the end user device 16.

In step 124, the process invokes the downloaded fingerprint engine 52a and generates a fingerprint of the audio piece. In step 126 the process performs a fingerprint lookup of the audio piece. In this regard, the process transmits a fingerprint lookup request with the generated fingerprint to the recommendation server 12. The recommendation server 12 receives the fingerprint lookup request, and in response, performs a lookup of the received fingerprint in the fingerprint database 74. If the recommendation server 12 finds a match, an acoustic attribute vector 72a associated with the matched fingerprint 70a is retrieved and transmitted to the end user device 16. Other types of profile vectors such as, for example, an album and/or artist profile vector 76a, 78a associated with the retrieved acoustic attribute vector 72a may also be retrieved and transmitted to the end user device 16.

In step 128, a determination is made as to whether the metadata and fingerprint lookups were successful, meaning that the lookups have each returned an acoustic attribute vector 72a. If the answer is YES, the audio piece is deemed to be verified in step 134.

According to one embodiment of the invention, accuracy of the audio piece's metadata may also be checked as part of the verification process. In this regard, the process compares the acoustic attribute vector returned from the metadata lookup to the acoustic attribute vector returned from the fingerprint lookup to determine if the two profile vectors are the same. If they both return the same profile vector, an assumption may be made that the metadata associated with the audio piece is accurate.

In step 136, the process returns the processed information including the identified metadata, generated fingerprint, and the acoustic attribute vector from the metadata and fingerprint lookups. Album and artist profile vectors 76a, 78a may also be returned if retrieved from the recommendation server 12 from the metadata and/or fingerprint lookups. Any other information identified by the process for the audio piece is also returned in step 134.

Referring again to step 128, if the metadata and fingerprint lookups failed to return an acoustic attribute vector 72a, the process invokes the downloaded analysis engine 50a in step 140, and locally analyzes the audio piece for generating its acoustic attribute vector.

In step 142, a determination is made as to whether the audio piece could successfully be analyzed. If the analysis was successful, the acoustic attribute vector generated as a result of the local analysis is uploaded to the recommendation server 12 in step 144, along with the audio piece's fingerprint and metadata. The process further returns the processed information including the identified metadata, generated fingerprint, and the generated acoustic attribute vector. Updated album and artist profile vectors 76a, 78a may also be returned if retrieved from the recommendation server 12. Alternatively, the updating and/or calculation of the album and artist profile vectors occurs locally at the end user device. Any other information identified by the process for the audio piece is also returned in step 146.

If, however, the analysis during step 140 was unsuccessful, no acoustic attribute vector is generated for the audio piece, and the process simply returns, in step 148, an unanalyzable message along with the identified metadata and any other information identified for the audio piece. According to one embodiment of the invention, although the audio piece is unanalyzed, the audio piece is nonetheless available via the mixer GUI for viewing its metadata and associated information, searching the metadata, and playing. The audio piece, however, may not be available for generating automated playlists or making other types of recommendations that would require the audio piece's acoustic attribute vector.

According to one embodiment of the invention, analyzed audio pieces are visually identified for allowing a user to easily determine which audio pieces are active audio pieces due to having analysis data associated with them. In this regard, songs appear in red if they have not yet been analyzed, green if they have been successfully analyzed, and black if they cannot be analyzed.

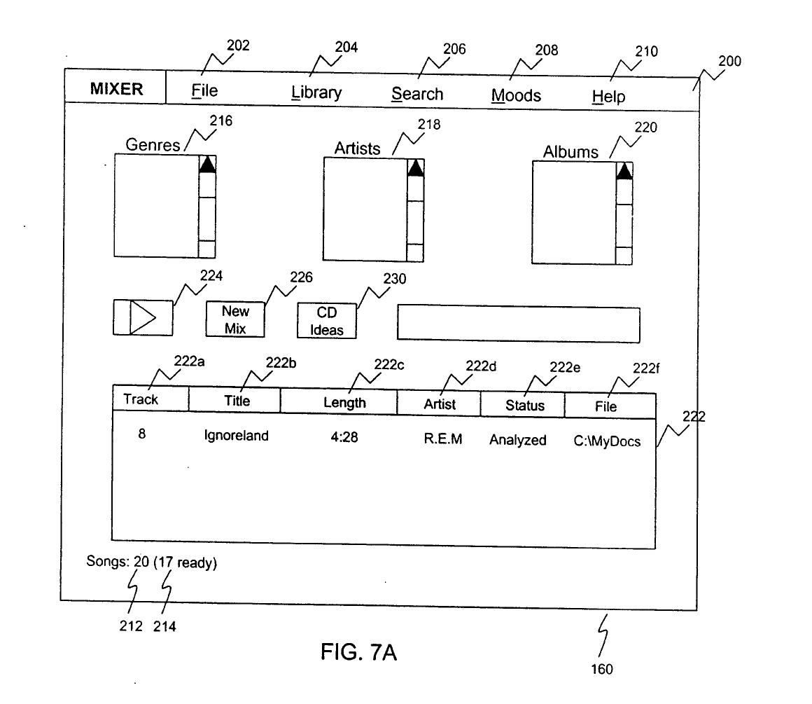

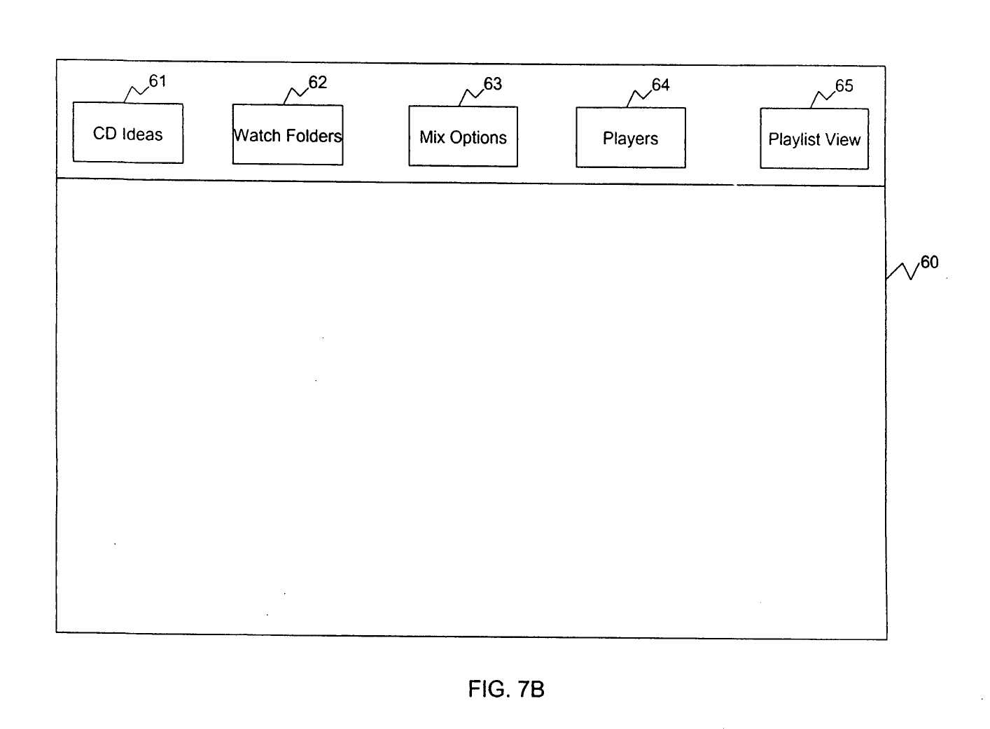

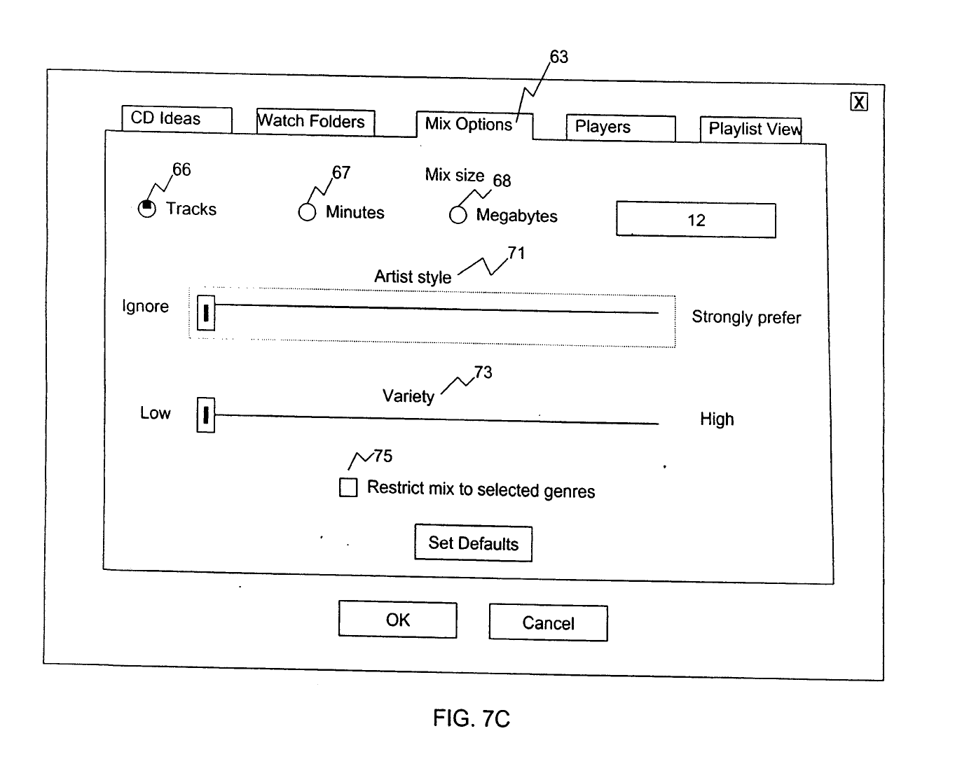

FIGS. 7A-7C are illustrations of a mixer GUI 160 generated by the downloaded mixer GUI engine 56a according to one embodiment of the invention. The mixer GUI 160 is displayed on a display screen of the end user device in response to a user request. The mixer GUI 160 includes a menu bar 200 having one or more selectable menus, such as, for example, a file menu 202, library menu 204, search menu 206, moods menu 208, and help menu 210. A total number of songs 212 that have been added to the music library 39 is depicted on one portion of the mixer GUI. Also displayed next to the total number of songs is a number of songs that have an acoustic attribute vector, that is, analysis data, associated with them.

The genre, artists, and albums associated with the songs in the music library 39 are respectively displayed in a genres window 216, artists window 218, and albums window 220. Metadata and other information of songs associated with a selected genre, artist, and/or album are displayed in a songs window 222. A user may search for particular artists, albums and songs via a selection of the search menu 206. A user may also request for similar albums and artists by right-clicking on a particular album or artist, and transmitting a corresponding command.

The songs window 222 provides information about a song such as, for example, a track number field 222a, a song title field 222b, a song length field 222c, an artist name field 222d, a status field 222e, and a file field 222f. The status field 222e indicates the status of a song in addition to, or in lieu of, the use of different colors to depict its status. The status field thus indicates whether the song has been analyzed, pending to be analyzed, or unable to be analyzed.

A file field 222f identifies the location in memory where the actual audio piece is stored. The audio piece is retrieved from the stored location and sent to an audio player when the audio piece is to be played.

The mixer GUI 160 further includes a play icon 224, new mix icon 226, shuffle icon 228, and e-commerce icon 230. A user may highlight one or more audio pieces in the songs window 222 and select one of these icons to cause different actions to be performed by the mixer GUI. For example, selection of the play icon 224 causes the processor 30 to invoke one of the audio player softwares 53 to play the highlighted audio pieces. If no songs have been highlighted, the processor invokes the audio player software 53 to play all of the songs displayed in the songs window 222.

Selection of the e-commerce icon 230 causes the downloaded e-commerce engine 58a to search across one or more distinct databases of one or more providers for recommendations of songs, albums, and/or the like, similar to a selected audio piece(s), album(s), and/or artist(s). The songs and/or albums recommended as a result of searching the provider database(s) are then displayed by the e-commerce engine 58a on the web browser 51 hosted by the end user device 16. According to one embodiment of the invention, the recommended songs and/or albums include new music not currently stored in the user's music database 39. The new music may then be purchased, listened, and/or downloaded from the provider over the Internet 18 as part of, for example, an e-commerce transaction between the user and the provider.

Selection of the new mix icon 226 generates a playlist of songs that are similar to the highlighted audio piece(s), album(s), or artist(s). The generated playlist of songs is displayed in the songs window 222, and may be played by the audio player software according to the indicated order upon selection of the play icon 224.

The generated playlist may also be saved in the memory 32 or mass storage device 38 by selecting a save playlist option (not shown) from the file menu 202. Individual songs may also be dragged and dropped for storing in the mass storage device according to conventional mechanisms.

An open playlist option allows a saved playlist to be retrieved from the memory and re-displayed in the songs window 222.

Selection of the shuffle icon 228 changes the order of songs in a current playlist, thereby changing the order in which the songs are played. According to one embodiment of the invention, the processor 30 provides four different types of shuffling mechanisms: random shuffle; sawtooth shuffle; smooth shuffle; and jagged shuffle. The user may decide which shuffling mechanism will be associated with the shuffle icon 228 by right-clicking on the shuffle icon 228 and selecting one of the shuffling mechanisms as the default shuffling mechanism. The sawtooth, smooth, and jagged shuffles are acoustic shuffling mechanisms that determine the sequence of the songs to be played based on the acoustic properties of the songs.

Random shuffling places the songs in the playlist in a random order. Smooth shuffling places the songs in the playlist in an order that minimizes the changes between each adjacent song, providing a smooth transition from one song to another. Jagged shuffling places the songs in the playlist in an order that maximizes the changes between each adjacent song, providing a jump from one song to another. Sawtooth shuffling places the songs in the playlist in an order that alternates the songs between loud and quiet songs. According to one embodiment of the invention, double-clicking on a particular artist or genre causes the playing of all the songs in the music library that are associated with the selected artist or genre, sequenced according to the pre-selected shuffling mechanism.

According to one embodiment of the invention, various features of mixer GUI 160 may be customized upon selection of a customization option (not shown) from the file menu 202. Selection of the customization option causes display of a pop-up window 60 with various customization options. For example, a CD-ideas customization option 61 provides a list of currently known providers that may be able to recommend songs, albums, and/or the like for purchase, download, or listening. According to one embodiment of the invention, the list of providers is retrieved and transmitted by the server 12 for use by the end device for the duration of a current session.

The user selects one or more of the listed providers and sets them as the default providers to be queried when the user is seeking for an external recommendation.

A watch folders option 62 lists the folders identified by the user as containing audio files, and indicates whether such folders are automatically monitored for detecting new audio files to be analyzed and included in the music library 39. According to one embodiment of the invention, all folders identified by the user are, by default, selected for automatic monitoring. The watch folders option provides a user the option to de-select one or more of the listed folders and prevent them from being automatically monitored. A user may also manually add folders to the list of monitored folders via the watch folders option 62.

A players option 64 provides a list of audio player softwares 53 supported by the end user device 16. The players option 64 further allows the user to select one of the listed player softwares as the default player to be used when playing an audio piece.

A playlist view option 65 allows a user to customize the type of information to be displayed in the songs window 222. Such information may include song title, album name, artist name, song duration, song track number, file location, genre, and the like. In this regard, the user selects the desired fields from a first list of all available fields, and adds them to a second list of fields to be displayed in the songs window.

A mix options 63 allows customization of a playlist that is automatically generated by the downloaded recommendation engine 52a. As illustrated in FIG. 7C, the size of the playlist may be customizable based on a number of tracks 66, playing time 67, or buffer size 68.

The mix options 63 also allows the user to customize the factors to be considered when generating the playlist. For example, the user may enable genre filtering to remove songs from undesired categories. In this regard, the user selects desired genres from the genres window 216 and selects a command 75 to restrict the mix to the selected genres. When genre filtering is enabled, the user may also ban genres from a playlist by right clicking on an offending song, and selecting a hide genre command. For example, selection of a hide genre command after right clicking on a country song causes the recommendation engine 54a to remove all country songs from the playlist, and deselects the country genre as a desired category.

According to another embodiment of the invention, other types of filtering may be achieved in addition to genre filtering. For example, filtering may be accomplished based on an album name, an artist name, other metadata, or some customized filter criteria.

According to one embodiment of the invention, if a user perceives the playlist as being too diverse due to having too many songs with different styles, the mix option 63 allows a user to have the recommended songs follow the style of the artist(s) of the selected audio piece(s) on which the playlist is based. The user may do so by manipulating an artist style sliding bar 71 which, if set on one extreme, the artist's style is ignored, and if set on an opposite extreme, the artist's style is strongly preferred. If the artist's style is strongly preferred, the recommendation engine 54 selects songs for the playlist that closely follow the selected artist's style, and helps reduce the diversity of the recommended songs due to the diversity of artists styles. According to one embodiment of the invention, an artist's style for a selected song may be determined if the song is contained in an album having a threshold number of tracks (e.g. six tracks), or if the music library 39 contains a threshold number of songs for the same artist.

If, on the other hand, the user perceives that the playlist is not diverse enough and more variety is desired, the customize option allows a user to have the recommended songs be more diverse by manipulating a variety sliding bar 73 which, if set on one extreme, indicates a high preference for variety, and if set on an opposite extreme, indicates a low preference for variety. According to one embodiment of the invention, more variety may also be introduced in the playlist by increasing the number of tracks that will appear in the list.

If the user dislikes one or more songs recommended on the playlist, the user may actuate a “less like this” command by right clicking on the song and selecting the corresponding menu option. In response to such a command, the recommendation engine 54 creates a new playlist that removes the undesired songs from the playlist as well as other songs that are similar to the undesired songs. The user may also simply delete the undesired songs from the playlist without causing the generation of a new playlist by selecting a remove songs option (not shown) from the library menu 204.

If, however, the user particularly likes one or more songs recommended on the playlist, the user may actuate a “more like this” command by right clicking on the desired songs and selecting the corresponding menu option. In response to such a command, the recommendation engine 54a creates a new playlist that adds more songs that are similar to the selected songs.

A current playlist that is manually or automatically generated may also be used to generate a second playlist which is similar, but contains none of the same songs. In this regard, the user, after generating a first playlist, actuates a command to morph the playlist by selecting a “morph playlist” option from the library menu 204. In response to this command, the analysis engine 50a generates a group profile for one or more songs on the playlist, and invokes the recommendation engine 54 to make a recommendation of similar songs based on the generated group profile.

According to one embodiment of the invention, the manually or automatically generated playlist may further be stored under a particular mood name by selecting a “save as mood” option (not shown) from the moods menu 208. For example, the playlist may contain a list of songs that make the listener happy, and thus, be saved under the mood name “happy.” In response to the user command to save the current playlist under a particular mood name, the analysis engine 50a generates a group profile for the songs in the playlist and associates the identified mood name to the group profile. The saved mood is then displayed on the mood menu 208. Upon actuation of a save mood entry, the recommendation engine 54a makes a recommendation of similar songs that are based on the group profile associated with the mood entry.

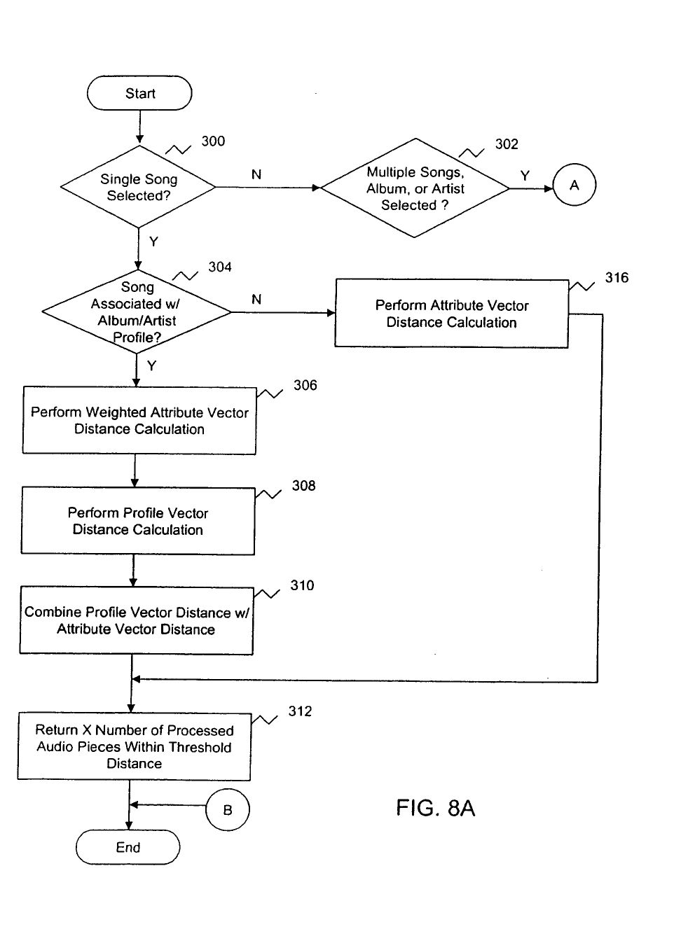

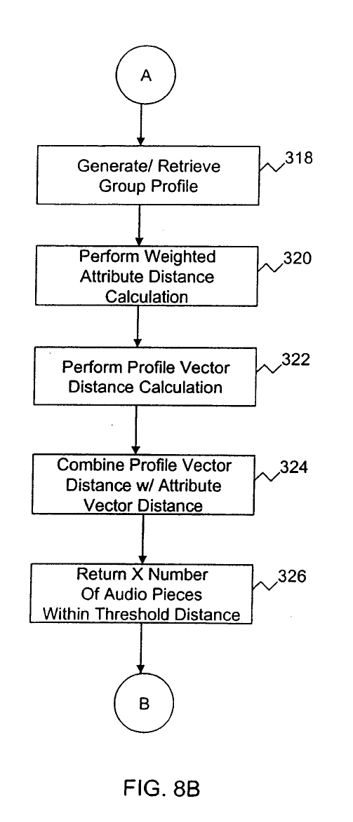

FIGS. 8A-8B are flow diagrams of a process for generating a playlist upon the selection of the new mix icon 226 or a stored mood entry according to one embodiment of the invention. The process determines, in steps 300 and 302, whether the user selected a single song, multiple songs, an artist, an album, or another group, such as, for example, a particular mood group, for generating the playlist.

If the user selected a single song, the process determines, in step 304, whether the selected song is associated with an album and/or artist profile vector. According to one embodiment of the invention, an album profile vector exists for a particular song if the particular song is contained in an album having a threshold number of songs that have been successfully analyzed. An artist profile vector exists for the particular song if the music library 39 contains a threshold number of songs that have been successfully analyzed for the same artist.

If an album and/or artist profile vector does not exist for the selected song, the process, in step 314, invokes the recommendation engine 54a to perform attribute vector distance calculations between the acoustic attribute vector of the selected song, and the acoustic attribute vectors of the eligible audio pieces in the music library 39. According to one embodiment of the invention, the eligible audio pieces that may be recommended are the audio pieces that have been successfully analyzed to generate an acoustic attribute vector. If genre filtering or other types of filtering have been enabled, the eligible audio pieces are the successfully analyzed audio pieces that belong to the desired genre or meet some other predetermined filter criteria. A determination may be made as to whether an audio piece belongs to a particular genre by examining the metadata associated with the audio piece.

If, however, the selected song is associated with an album and/or artist profile vector, the process, in step 306, invokes the recommendation engine 54a to perform a weighted attribute vector distance calculation between the attribute vector of the selected song, and the attribute vector of the eligible audio pieces in the music library 30. In performing a weighted attribute vector distance calculation, the recommendation engine 54a gives more weight to attributes whose coefficient values, as stored in the selected song's album and/or artist profile vector, are above a particular threshold, than those attributes whose coefficient values are below the particular threshold.

In step 308, the process invokes the recommendation engine 54a to perform album and/or artist profile vector distance calculations between the album and/or artist profile vector of the selected song, and the album and/or artist profile vector of each of the eligible audio pieces in the music library 39.

In step 310, the album and/or profile vector distance between the selected song and an eligible song is combined with the computed attribute vector distance based upon a predetermined combination ratio. According to one embodiment of the invention, the ratio of the album and/or artist profile vector distance to the acoustic attribute vector distance depends on the setting of the artist style sliding bar 71 (FIG. 7C). Thus, the more the artist's style is preferred, the higher the ratio of the album and/or artist profile vector distance to the acoustic attribute vector distance.

In step 312, the recommendation engine 54a returns all or a portion of the processed audio pieces as the recommended pieces for the playlist. In this regard, the recommendation engine 54a may identify audio pieces whose total vector distance is below a threshold distance. According to one embodiment of the invention, the threshold distance depends on the setting of the variety sliding bar 73 (FIG. 7C). Thus, the higher the setting of the variety sliding bar towards a high preference for variety, the higher the selected threshold distance.

The recommendation engine 54a further selects as many audio pieces from the identified set of audio pieces that would satisfy the desired playlist size. The audio pieces selected from the identified set may also depend on the setting of the variety sliding bar 73. For example, if the setting of the variety sliding bar indicates a high preference for variety, the recommendation engine 54a selects audio pieces that maximizes their total vector distance.

According to another embodiment of the invention, the recommendation engine 54a selects products that lie within a user's positive preference cluster, that is, a cluster of audio pieces with which the user has made a positive association. Thus, if six audio pieces are to be recommended on the playlist, the recommendation engine 54a identifies six different positive clusters to the extent possible, and recommends one product near each cluster. If less clusters are identified than the amount to generate the playlist, the engine reuses one or more clusters to satisfy the request. The recommendation engine 54 is described in more detail in U.S. patent application Ser. No. 09/556,051.

Referring again to step 302, if the user selected multiple songs, an album, an artist, or some other group, such as, for example, a mood group, as the basis of the playlist request, the process invokes, in step 318, the analysis engine 50a for either generating or retrieving a corresponding group profile vector for the selected group.

In step 320, the process invokes the recommendation engine 54a to perform a weighted attribute vector distance calculation between each song in the selected group, and the various eligible songs in the music library 39.

In step 322, the recommendation engine 54a calculates a vector distance between the generated group profile vector and the album and/or artist profile vector of the various eligible songs in the music library 39.

In step 324, the computed profile vector distance is combined with each computed attribute vector distance. Again, the ratio used for combining the profile vector distance and the attribute vector distance may depend on the setting of the artist style sliding bar 71.

In step 326, all or a portion of the processed audio pieces are returned as the recommended playlist. According to one embodiment of the invention, the recommendation engine 54a returns N number of songs with the smallest distance calculation. According to another embodiment, the recommendation engine 54a may return for each song in the selected group, a certain number of audio pieces whose calculated vector distance is below a particular threshold distance.

According to another embodiment of the invention, the recommendation engine 54a skips steps 320 and 324, and simply performs profile vector distance calculations if the playlist is to be based on multiple songs selected by the user, an album, an artist, or a mood group. In this scenario, the recommendation engine 54a returns N audio pieces with the smallest distance calculation. According to another embodiment, the engine returns a certain number of audio pieces from each album whose album profile distance is below a threshold distance.

According to one embodiment of the invention, selection of the “morph playlist” option generates a new playlist that is based on the current playlist. In this regard, a process similar to the process illustrated in FIG. 8B is invoked for generating the morphed playlist. However, in generating the morphed playlist, the group profile that is generated is the group profile of all the songs in a current playlist. Furthermore, the audio pieces are selected so that no repetitions occur between the current playlist and the new playlist.

According to one embodiment of the invention, selection of a “more like this” command for a highlighted song(s) in a current playlist causes the generation of a new playlist that adds more songs similar to the selected song(s). In this regard, the process in FIGS. 8A-8B is reinvoked based on the highlighted song(s) for generating the second playlist.

Conversely, selection of a “less like this” command for a highlighted song(s) in a current playlist causes the generation of a second playlist with the undesired song(s) removed. Other songs that may be similar to the undesired song(s) are also removed. According to one embodiment of the invention, the process in FIGS. 8A-8B is invoked for identifying songs that are similar to the undesired song(s). The identified songs may then be removed from the current playlist, and more songs added to replace the removed songs.

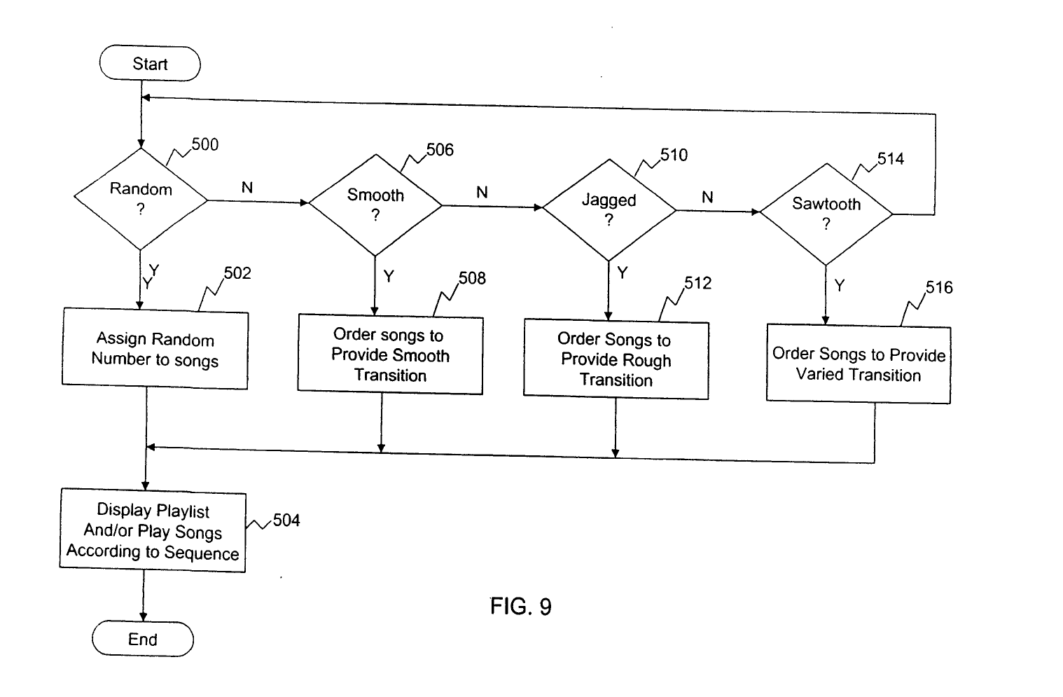

After a playlist is generated, a user may decide the sequence of the songs on the playlist by selecting one of various acoustic shuffling mechanisms. FIG. 9 is a flow diagram for shuffling the order of songs of a playlist according to one embodiment of the invention. In step 500, a determination is made as to whether the shuffle icon 228 (FIG. 7A) is associated with random shuffling as its shuffling mechanism. If the answer is YES, the process assigns random numbers to the songs in the playlist. In step 504, the process displays the songs according to the assigned numbers and/or immediately starts playing the songs according to the determined sequence.

If the shuffle icon 228 is associated with the jagged, smooth, and sawtooth shuffling mechanism, acoustic properties of the songs are considered in determining the sequence of the songs. In this regard, in step 506, a determination is made as to whether smooth shuffling has been selected as the default shuffling mechanism. If the answer is YES, the songs are ordered in step 508 so as to provide a smooth transition from one song to another. In this regard, the task of ordering the songs is tackled as a traveling salesman problem, which is well known to those of skill in the art, and solved by ordering the songs so as to minimize a total distance across all, or a portion of, the attributes of the audio profiles of the songs in the playlist. This may cause the songs to become increasingly or decreasingly louder in tone as the songs progress on the playlist. According to another embodiment of the invention, instead of generating a smooth transition from a single song to another, smooth shuffling provides a smooth transition from one group of songs to another.

In step 510, a determination is made as to whether jagged shuffling has been selected as the default shuffling mechanism. If the answer is YES, the songs are ordered in step 512 so as to provide a rough transition from one song to another, where the changes between each adjacent song in the playlist is maximized. In this regard, the problem may be equated to a reverse traveling salesman problem, which is also well known to those of skill in the art, and solved by ordering the songs so as to maximize a total distance across all, or a portion of, the attributes of the audio profiles of the songs in the playlist. According to another embodiment of the invention, instead of generating a rough transition from a single song to another, jagged shuffling provides a rough transition from one group of songs to another.

In step 514, a determination is made as to whether a sawtooth shuffling has been selected as the default shuffling mechanism. If the answer is YES, the songs are ordered in step 516 so as to vary the sound or speed of the songs in a fast-slow-fast pattern. In this regard, the songs are divided into two piles where one pile includes slow and/or quiet songs, and another pile includes fast and/or loud songs. Each pile is randomized and folded together like, for example, a deck of cards, to generate the varying sounds and/or speed. The various shuffling mechanisms also allow a user to easily change the sequence of the songs in a playlist without manually manipulating the order of the songs.

According to one embodiment of the invention, the mixer GUI allows a user to select an anchored, spontaneous acoustic shuffle and play option which applies a particular acoustic shuffle, that is, a random, jagged, smooth, or sawtooth shuffle, to a starting anchor point. The starting anchor point may be preset by a user via the mixer GUI, and may be an immediate context (such as an current song or a last played song), a random pick (which may include a song, genre, artist, or album), a random pick within a predefined filter, or a particular genre, artist, or album. For example, if the user sets the anchor point as a particular artist, selection of the anchored spontaneous acoustic shuffle and play option selects the particular artist as the starting point of the play sequence, and plays songs associated with the artist in the sequence that is dictated by the currently selected acoustic shuffle, before playing songs associated with another artist. The ability for a user to pre-determine the starting point of a play sequence provides the user with added flexibility in the listening sequence of songs without the user having to pre-program the playlist each time.

According to one embodiment of the invention, the scope of a spontaneous acoustic shuffle and play may be restricted by a set filter. The filter may be based on any combination of metadata information such as genre, artist, album, composer, publication date, rating, beats per minute, and other like information. Thus, if a filter is set to exclude music in a particular album, selection of the anchored spontaneous acoustic shuffle and play option causes the playing of the songs for the selected anchor point, but excludes songs in the particular album.

According to one embodiment of the invention, a user may search for artists or albums similar to a selected artist or album by right-clicking on the artist or album from the artists or albums window 218, 220 (FIG. 7A), and selecting a command to search for similar artists or albums. According to one embodiment of the invention, a list of similar artists or albums may be determined if the music library 39 includes at least a threshold number of analyzed songs for the selected artist or album.

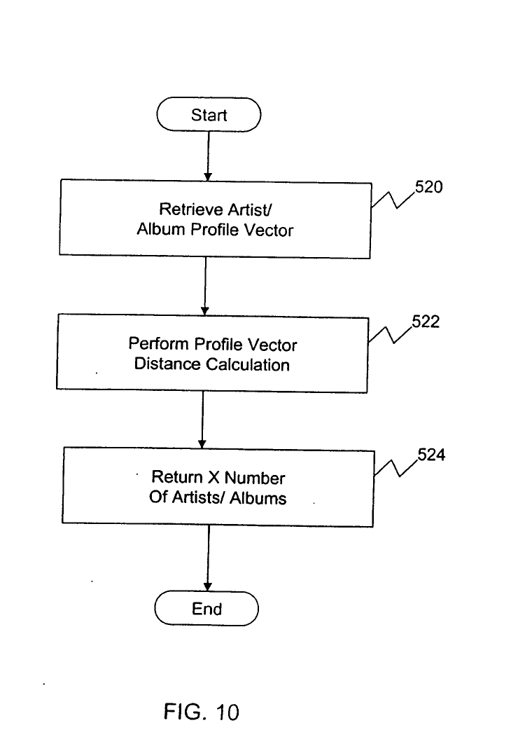

FIG. 10 is a flow diagram of a process for generating a list of similar artists or albums according to one embodiment of the invention. In step 520, responsive to the command to search for similar artists or albums, the recommendation engine 54a proceeds to retrieve an artist or album profile vector for the selected artist or album, respectively. In step 522, the recommendation engine 54a performs profile vector distance calculations between the artist/album profile vector for the selected artist/album, and the eligible artist/album profile vectors in the music library 39. In step 524, the recommendation engine 54a returns a predetermined number of artists/albums whose profile vector distances are below a threshold distance.

According to one embodiment of the invention, the user may receive ideas for new music not currently in the user's music database 39, for purchase, download, and/or listening. In this regard, the user selects via the mixer GUI 160, a song, album, and/or artist in the user's own music library 39 on which the recommendation is to be based. Selection of the e-commerce icon 230 following the user's selection causes the downloaded e-commerce engine 58a to display on the web-browser 51 a hosted by the end user device 16, a list of ideas for new songs, albums, and/or the like (collectively referred to as new music), that are similar to the user's selection(s). The suggestions are linked to one or more retailer servers 20, which may then be accessed for buying, downloading, and/or purchasing the recommended new music.

According to another embodiment of the invention, the initial song, album, or artist selected by the user for requesting ideas for new music may not be part of the user's own music library 39. Instead, the user may, via the web browser 51, access an external service provided by, for example, the web server 22 (FIG. 1) or even the retailer server 20 or recommendation server 12, and select a song, album, or artist maintained by the external service for which the user wants suggestions for new music. According to this embodiment, the external service need not store actual music files in its data store. However, the external service maintains a mapping of various songs, albums, or artists to their appropriate attribute or group profile vectors. Such vectors may be generated locally via a local analysis engine, or downloaded from the recommendation server 12.

The external service may further host an external e-commerce engine that may be similar to the e-commerce engine 58a hosted by the end user device 16.

Regardless of whether the e-commerce engine is hosted by the end user device 16 or external service, the engine connects to a recommendation engine in response to the user selection of the e-commerce icon 230. The recommendation engine may be hosted in any server having access to information of music available for sale by one or more retailers, such as, for example, the retailer servers 20, recommendation server 12, or external web server 22. The e-commerce engine, transmits a request for songs similar to the songs selected by the user to the recommendation engine, and receives an appropriate response. The response may be, for example, a list of possible purchases similar to the user's selection, along with their associated metadata. The metadata may include, for example, the artist's name, album name, album cover, UPC number, URL link to a website associated with a recommended song or album, and the like. The transmitted response may further include for each possible purchase, a link to the retailer from which the music may be obtained, and an associated acoustic attribute vector, album profile vector, and/or artist profile vector. The client may use the returned metadata to combine results from different providers and rank them appropriately, remove duplicates, generate displays of the recommendations, and/or the like.

The returned vectors may also be used for duplicate removal. For example, the acoustic attribute vectors of the songs that are recommended may be used as loose fingerprints, either alone or in combination with the returned metadata, in order to detect duplicates. Audio fingerprints such as audio fingerprints generated by an audio fingerprint engine may also be returned for the recommended songs and used by the client for removing duplicates.

According to one embodiment of the invention, each provider, such as, for example, the retailer server 20, includes a provider recommendation engine, which may be similar to the recommendation engine 54 hosted by the recommendation server 12. The provider recommendation engine makes recommendations of songs, albums, and/or artists based on acoustic attribute, album profile, and/or artist profile vectors received from the client. Each provider may further provide a web service to allow the end user devices 16 and/or recommendation server 12 to perform a lookup of products offered by the provider.

According to one embodiment of the invention, when a provider receives a recommendation request from an e-commerce engine, it forwards the query to the provider recommendation engine. The provider recommendation engine makes recommendations of purchases based on a comparison of the received vector(s) with attribute vectors, album profile vectors, and/or artist profile vectors associated with the music in its product database. The product database may reside, for instance, in one or more retailer data stores 24 or in the central data store 14 maintained by the recommendation server 12.

According to one embodiment of the invention, acoustic attribute vectors and/or group profile vectors for music in the provider's product database may be generated locally by a provider analysis engine, which may be similar to the analysis engine 50 hosted by the recommendation server 12. According to another embodiment of the invention, the vectors may be downloaded from the recommendation server 12 or from a reseller of such data. For example, the reseller may take the form of the web server 22 maintaining and/or locally generating acoustic attribute, album profile, and/or artist profile vectors for popular CDs based, for example, on their universal product code numbers.

According to one embodiment of the invention, the web server 22 may operate between a remote e-commerce engine and various retailers, independent artists, and the like. For example, the web server 22 may receive a recommendation request from the e-commerce engine and forward the request to the various retailers and independent artists. As each contacted retailer and artist provides a list of recommended music, the web server 22 may aggregate the recommendations with or without any duplicates removed, and forward the aggregate recommendations to the e-commerce engine.

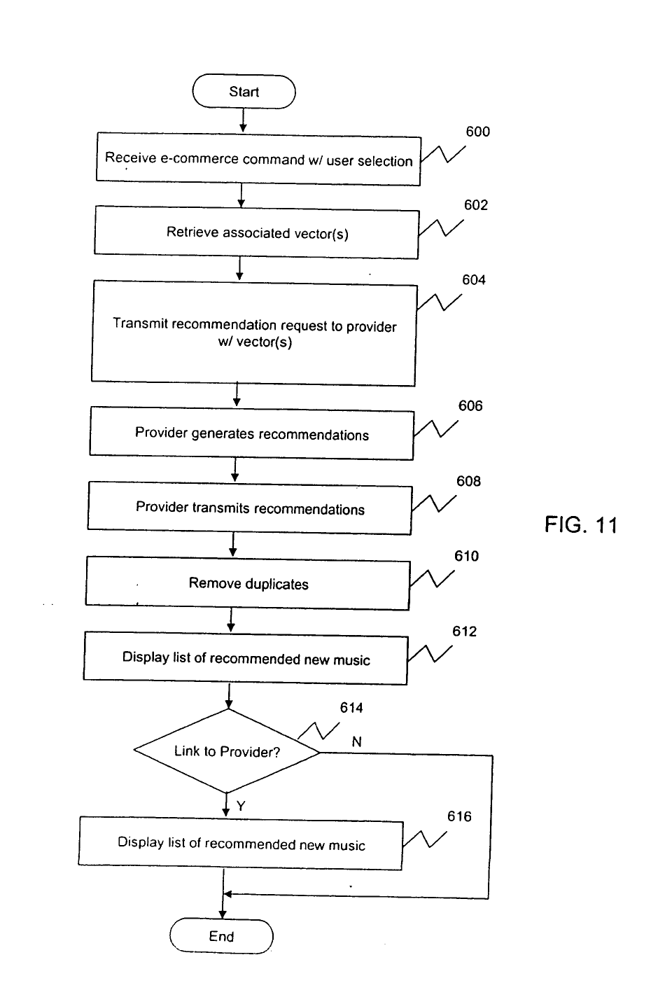

FIG. 11 is a flow diagram of a process for receiving recommendations of songs or albums provided by different providers for purchase, download, and/or listening, according to one embodiment of the invention. In step 600, the e-commerce engine 58a downloaded by the end user device 16 receives an e-commerce command transmitted with a user selected song, album, or artist. The e-commerce command may be transmitted, for example, in response to a user selection of the e-commerce icon 230.

In step 602, the e-commerce engine retrieves a group profile associated with the user's selection. One or more attribute vectors for the selected song(s), or songs in a selected group, may also be retrieved.

In step 604, the e-commerce engine transmits a recommendation request to a pre-determined provider such as, for example, Amazon.com®. According to another embodiment of the invention, the recommendation request may be directed to another server with access to information on the music that is provided by the provider, such as, for example, the recommendation server 12 or web server 22.

According to one embodiment of the invention, the recommendation request includes the retrieved group profile vector and/or attribute vector(s), but hides other details about the initial song, album, or artist that was selected, which a user may not want to disclose to the provider.

The provider or other server receives the recommendation request, and in step 606, invokes its own or an associated recommendation engine to generate a recommendation based on the received vector(s). According to one embodiment of the invention, the recommendation engine performs vector distance calculations between the received vector(s) and vectors of music in its product database, for retrieving a list of products to be recommended. For example, the retailer server 20 may receive the recommendation request with a group profile vector associated with a user's selection, and perform vector distance calculations between the received vector and album and/or artist profile vectors in the retailer data store 26. In step 608, the songs and/or albums whose vector distances are within a predetermined threshold distance are then selected as the recommended music and returned to the e-commerce engine. Metadata for the recommended music and one or more vectors may also be returned by the provider.

The e-commerce engine receives the list of recommended music and in step 610, proceeds to remove from the list songs and/or albums already in the user's music database 39. This may be done, for example, via metadata comparisons, attribute vector comparisons, profile vector comparisons, fingerprint comparisons, and/or the like.

In step 612, the filtered list is displayed on the web browser hosted by the end user device 16 as a list of new music ideas. The display form and/or content may vary based on the provider providing the recommendation. For example, if the provider is Amazon.com®, album covers for the new music ideas are displayed along with the album and artist's name. If the provider is CDBaby.com, individual songs are listed along with the album and artist's name.

According to one embodiment of the invention, each displayed recommendation includes a link to a provider's server to purchase, download, and/or listen to the recommendation. In this regard, a determination is made in step 614 as to whether the user has selected a particular recommendation for accessing the provider's web server. If the answer is YES, a Uniform Resource Locator (URL) request for the provider's web server is generated in step 616 for connecting to the provider. For example, the provider's web server may provide a web page that allows the user to enter into an electronic purchase transaction to purchase, for example, a CD recommended by the provider. In another example, the provider's web server may provide an audio file for allowing the user to listen or download the recommended song.

According to one embodiment of the invention, the URL request used to connect to the provider includes a source identifier identifying a source associated with the request. The source identifier may be used to identify an entity with whom a part of the revenue generated from a purchase or downloading of recommended music, is to be shared. For example, in the scenario where the recommendation of new music is provided by the recommendation server 12 or external web server 22 having access to music selections provided by the retailers 20, each recommendation includes a link to the particular retailer selling the music. The link contains the retailer's domain name as well as an identifier of an entity associated with the recommendation server 12 or web server 22 that generated the recommendation. If the recommendation results in an actual click of the link to transmit a URL request to the provider's web site followed by a purchase of the music from the web site, the retailer server 20 identifies the source of the URL request embedded in the link for sharing a portion of the generated revenue with the associated entity. In this regard, the retailer server 20 may calculate a payment amount due to the entity based on the purchase price, and credit an entity's account maintained at the retailer server with the payment amount.

The automatic profiling, recommendation, and purchasing system of FIG. 1 may also be embodied in a radio system, such as, for example, the radio system described in further detail in U.S. patent application Ser. No. 09/885,307. According to this embodiment, the end user device 16 takes the form of digital radio that populates its music database based on audio pieces transmitted in one or more broadcast channels. The music database according to this embodiment, is dynamic in that it stores the audio pieces received via the broadcast channels on a temporary basis.

According to one embodiment of the invention, the acoustic attribute and/or group profile vectors associated with the transmitted audio pieces may be transmitted via a separate broadcast channel in advance to the broadcast of the associated audio pieces. According to another embodiment of the invention, the receiving radio device may include an analysis engine for analyzing the received audio pieces in real time.

The radio device further includes a recommendation engine for generating a playlist based on the audio pieces currently in its music database. For example, as the user is listening to a current broadcast channel, he/she may find one of the songs particularly desirable, and may want the following broadcasted songs to be similar to the identified song. A mixer GUI similar to the mixer GUI 160 of FIGS. 7A-7C may be invoked for allowing the user to select the desired song and select an icon similar to the new mix icon 226 for causing the recommendation engine to identify and download songs from various broadcast channels that are deemed to be similar to the identified song.

Although this invention has been described in certain specific embodiments, those skilled in the art will have no difficulty devising variations to the described embodiment which in no way depart from the scope and spirit of the present invention. For example, the processes of the various flow diagram are software routines executed by the processor 30 based on instructions stored in the memory 32. A person of skill in the art should recognize, however, that the processes may be executed via hardware, firmware (e.g. via an ASIC), or in any combination of software, firmware, and/or hardware. Furthermore, the steps of the processes may be executed in the indicated order or in any other order recognized by a person of skill in the art.

In addition, to those skilled in the various arts, the invention itself herein will suggest solutions to other tasks and adaptations for other applications. For example, although the various embodiments are directed to a music recommendation system and method, these embodiments may be extended to other genres or products, such as, for example, movies, books, art, or the like. It is the Applicants' intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. In a recommendation system including a server coupled to an end user device over a data communications network, the server comprising:
a first data store storing an acoustic analysis database of acoustic analysis data for a plurality of audio pieces, the acoustic analysis data being generated based on an automatic processing of audio signals of one or more audio pieces, the acoustic analysis data providing numerical measurements for a plurality of predetermined acoustic attributes;
means for receiving a query for first acoustic analysis data associated with a first audio piece;
means for searching the acoustic analysis database for the first acoustic analysis data;
means for transmitting the first acoustic analysis data to the end user device responsive to a determination that the first acoustic analysis data is stored in the first data store and
means for receiving the first acoustic analysis data from the end user device responsive to a determination that the first acoustic analysis data is not stored in the first data store, the received acoustic analysis data being generated by the end user device by processing audio signals for the first audio piece.

2. The server of claim 1 further comprising:
a computer-readable medium storing computer instructions for processing audio signals and making recommendations based on the processed audio signals.

3. The server of claim 2, wherein the instructions further include instructions for generating a fingerprint of a particular audio piece.

4. The server of claim 2, wherein the means for searching the acoustic analysis database includes searching the database based on a fingerprint generated for the first audio piece.

5. The server of claim 2, wherein the computer instructions are transmitted to the end user device.

6. The server of claim 2, wherein the instructions, when executed by a processor, causes the processor to retrieve a second acoustic analysis data for the second audio piece, calculate a distance between the first acoustic analysis data and the second acoustic analysis data, and recommend the second audio piece based on the comparison.
